(19) United States
(12) Patent Application Publication
(10) Pub. No.: US 2013/0170101 A1
(43) Pub. Date: Jul. 4, 2013

(54) ELECTROCHEMICAL CAPACITOR

(71) Applicant: SAMSUNG ELECTRO-MECHANICS CO., LTD., Suwon-si (KR)

(72) Inventors: Sang Kyun LEE, Suwon-si (KR); Ji Sung CHO, Suwon-si (KR); Bae Kyun KIM, Seongnam-si (KR)

(73) Assignee: SAMSUNG ELECTRO-MECHANICS CO., LTD., Suwon-si (KR)

(21) Appl. No.: 13/732,042

(22) Filed: Dec. 31, 2012

(30) Foreign Application Priority Data
Dec. 29, 2011 (KR) 10-2011-0146364

(51) Int. Cl. H01G 9/145; H01G 9/035

(52) U.S. Cl. CPC H01G 9/145; H01G 9/035; B82Y 30/00
USPC 361/504; 361/508; 977/734

(57) ABSTRACT

Disclosed herein is a super capacitor electrical storage device, including a cathode and an anode respectively including electrode active materials having different average particle sizes, or a cathode and an anode respectively including electrode active materials having different pore structures in an active material.

According to the present invention, a large-capacitance electrochemical capacitor having excellent withstand voltage, energy density, input and output characteristics, and high-rate charging and discharging cycle reliability may be provided, by changing structures of electrodes and design of materials therefor.

### CROSS REFERENCE(S) TO RELATED APPLICATIONS

This application claims the benefit under 35 U.S.C. Section 119 of Korean Patent Application Serial No. 10-2011-0146364, entitled “Electrochemical Capacitor” filed on Dec. 29, 2011, which is hereby incorporated by reference in its entirety into this application.

### BACKGROUND OF THE INVENTION

1. Technical Field

The present invention relates to an electrochemical capacitor.

2. Description of the Related Art

In recent, an electric double layer capacitor (EDLC) has been successfully developed in relation to environmental problems because it has excellent input and output characteristics and high cycle reliability, as compared with a secondary battery, such as a lithium ion secondary battery or the like. For example, the electric double layer capacitor is promising as a power-storage device, which stores main power and subsidiary power of electric vehicles or renewable energy such as solar light, wind power, or the like.

In addition, the electric double layer capacitor is expected to be also utilized as a device capable of outputting large current for a short time with an uninterruptible power supply which is increasingly demanded by information technology (IT).

This electric double layer capacitor has a structure where a separator inserted between a pair of or a plurality of polarizable electrodes (cathode anode), which mainly consist of a carbon material, facing each other is immersed in an electrolytic liquid. Here, charges are stored on an electric double layer formed at an interface between the polarizable electrode and the electrolytic liquid.

Meanwhile, a capacitor using a lithium ion containing electrolytic liquid, that is, an asymmetric type electrochemical capacitor storage device has been suggested for the purpose of further increasing energy density. In this electrochemical capacitor electrical storage device including lithium ions, since a cathode and an anode are different from each other in view of materials therefor or functions thereof, an activated carbon is used for a cathode active material, and a carbon material capable of easily adsorbing or desorbing the lithium ions in reversibly is used for an anode active material. A separator is inserted between the cathode and anode, and the resultant structure is immersed in the electrolytic liquid containing a lithium salt. The electrochemical capacitor electrical storage device is used while the lithium ions are previously adsorbed on the anode.

FIG. 1 shows an operating principle and a basic structure of an electric double layer capacitor (EDLC). Referring to this, current collectors 10, electrodes 20, an electrolytic liquid 30, and a separator 40 are disposed from both sides of the electric double layer capacitor.

The electrode 20 consists of an active material made of a carbon material having a large effective specific surface area, such as an activated carbon powder, an activated carbon fiber, or the like, a conductive agent for imparting conductivity, and a binder for providing a binding force between respective components. In addition, the electrodes 20 include a cathode 21 and an anode 22 with a separator 40 therebetween.

In addition, as the electrolytic liquid 30, aqueous electrolytic liquid and non-aqueous (organic) electrolytic liquid are used.

The separator 40 is made by using polypropylene, Teflon, or the like, and serves to prevent a short circuit due to contact between the cathode 21 and the anode 22.

When voltage is applied to the EDLC at the time of charging, electrolytic ions 31a and 31b dissociated from surfaces of the cathode 21 and anode 22 are physically absorbed on the counter electrodes to store electricity. At the time of discharging, the ions of the cathode 21 and the anode 22 are desorbed from the electrodes, resulting in a neutralized state.

In cases of general electrochemical capacitors, expression of electrons due to absorbing and desorbing reactions of electrolytic ions on a surface of the activated carbon leads to achieving capacitance.

Recently, an increase in capacitance per unit volume is continuously requested due to a demand for size restriction over the entire use area of small-sized/medium or large-sized electrochemical capacitors.

A general electrochemical capacitor product has a structure in which the same voltage is applied to a cathode and an anode, as shown in FIG. 2. Presently, products of about 2.7 to 2.8V levels are known to realize the maximum voltage.

Meanwhile, strength of an anion in the electrolytic liquid, which adheres on the anode, is much greater than strength of a cation, which adheres on the cathode. As a representative example, there is about 3 times the difference in ion strength between a Li⁺ ion and a BF₄⁻ ion.

Therefore, in the case where the cathode and the anode are constituted in the same design, there is a difference in adsorbing and desorbing rates of ions adsorbed on the cathode and the anode. That is to say, in a case of designing by the same material and of the same electrode, there is a difference in ion rate on the cathode.

In general, the electrochemical capacitor needs to realize an equivalent level of capacitance even at the high current condition. (Requirements of high output) If there is a difference in rate due to a difference in ion strength or the like, high output characteristics may be deteriorated due to the cathode at which a decrease in rate is relatively expected under the conditions of high output.

Therefore, it is most advantageous to increase the voltage in view of increasing energy density. For achieving this, an activated carbon capable of realizing high voltage, an electrolytic liquid having a wide potential window that does not oxidized even at a high voltage region, an active material, and the like, are required, but development of materials satisfying theses needs is insufficient.

### SUMMARY OF THE INVENTION

There needs a balance in adsorption and desorption resistance levels of ions between a cathode/anode and an electrolytic liquid, in order to manufacture a high-output electrochemical capacitor. For realizing this, a design exceeding technical contradiction is needed.

An object of the present invention is to provide a large-capacitance electrochemical capacitor having excellent withstand voltage, energy density, input and output characteristics, and high-rate charging and discharging cycle reliability, by changing the structures of electrodes and design of materials therefor.

According to one exemplary embodiment of the present invention, there is provided an electrochemical capacitor, including: a cathode using an electrode active material having an average particle size of 10 μm or larger; and an anode using an electrode active material having an average particle size of below 10 μm.

The electrode active material of the anode and the electrode active material of the cathode may be the same as or different from each other, and each thereof may be at least one carbon material selected from the group consisting of activated carbon, carbon nanotube (CNT), graphite, carbon aerogel, polyacrylonitrile (PAN), carbon nanofiber (CNF), activated carbon nanofiber (ACNF), vapor-grown carbon fiber (VGCF), and graphene.

The electrode active material of the cathode may be activated carbon having a specific surface area of 1,500 to 2,000 m²/g.

The electrode active material of the anode may be activated carbon having a specific surface area of 2,000 to 3,000 m²/g.

According to another exemplary embodiment of the present invention, there is provided an electrochemical capacitor including a cathode using an electrode active material including mesopores of 2 to 50 nm in a content of 60 to 80%; and an anode using an electrode active material including of micropores of below 2 nm in a content of 60 to 80%.

The electrode active material of the anode and the electrode active material of the cathode may be the same as or different from each other, and each thereof is at least one carbon material selected from the group consisting of activated carbon, carbon nanotube (CNT), graphite, carbon aerogel, polyacrylonitrile (PAN), carbon nanofiber (CNF), activated carbon nanofiber (ACNF), vapor-grown carbon fiber (VGCF), and graphene.

The electrode active material of the cathode may be activated carbon having a specific surface area of 1,500-2,000 m²/g.

The electrode active material of the anode may be activated carbon having a specific surface area of 2,000 to 3,000 m²/g.

The activated carbon as the electrode active material of the cathode may be prepared by a vapor activation method. The vapor activation method may be performed at a temperature of 600 to 800° C.

The activated carbon as the electrode active material of the anode may be prepared by an alkali activation method.

The alkali activation method may be performed at a temperature of 600 to 1000° C.

The cathode may be formed more thinly than the anode by 5 to 40%.

The electrochemical capacitor may further include an electrolytic liquid.

The electrolytic liquid may include Br⁻, BF₄⁻, and TFSI⁻ as an anion.

The electrolytic liquid may include at least one selected from the group consisting of 1,3-dialkylimidazolium, N-alkylpyridinium, tetra-alkylammonium, and tetra-alkylphosphonium, as a cation.

### BRIEF DESCRIPTION OF THE DRAWINGS

FIG. 1 shows a basic structure and an operating principle of a conventional electric double layer capacitor; and

FIG. 2 shows voltage regions of a general electrochemical capacitor and voltage behavior applied to a cathode and an anode.

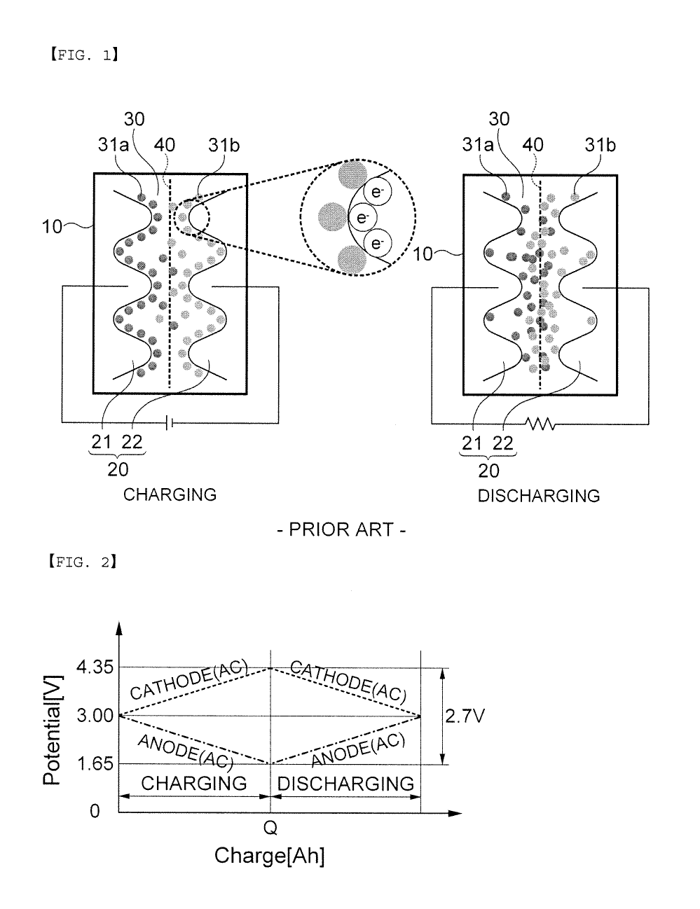

### DESCRIPTION OF THE PREFERRED EMBODIMENTS

Hereinafter, exemplary embodiments of the present invention will be described in detail.

Terms used in the present specification are for explaining the embodiments rather than limiting the present invention. Unless explicitly described to the contrary, a singular form includes a plural form in the present specification. Also, used herein, the word “comprise” and/or “comprising” will be understood to imply the inclusion of stated constituents, steps, operations and/or elements but not the exclusion of any other constituents, steps, operations and/or elements.

The present invention provides an electrochemical capacitor having a high withstand voltage by improving the design of a cathode and an anode and changing materials therefor.

According to a first exemplary embodiment of the present invention, electrode active materials being different from each other in view of a particle size are used for the cathode and the anode. In other words, since an anion in an electrolytic liquid, having a relatively ion diameter, is easily adsorbed and desorbed, an electrode active material having a large particle size is advantageous to the cathode. Also, an electrode active material having a relatively small particle size is advantageous to the anode.

Specifically, the cathode of the present invention preferably includes an electrode active material having an average particle size of 10 μm or larger. The above average particle size allows easy adsorption and desorption of an anion having a large ion diameter, which is included in the electrolytic liquid, thereby realizing a high-capacitance electrochemical capacitor.

The electrode active materials of the cathode may be the same as or different from each other, and each thereof may be at least one carbon material selected from the group consisting of activated carbon, carbon nanotube (CNT), graphite, carbon aerogel, polyacrylonitrile (PAN), carbon nanofiber (CNF), activated carbon nanofiber (ACNF), vapor-grown carbon fiber (VGCF), and graphene.

Among them, an activated carbon having a specific surface area of 2000-3000 m²/g may be most preferably used.

In addition, the anode of the present invention may include an electrode active material having a relatively small particle size, for example, an average particle size of lop or less, and preferably 5 to 8 μm, and thus, a cation having a small ion diameter, which is included in the electrolytic liquid, is easily adsorbed or desorbed, thereby realizing a high-capacitance electrochemical capacitor.

The electrode active materials of the anode may be the same as or different from each other, and each thereof may be at least one carbon material selected from the group consisting of activated carbon, carbon nanotube (CNT), graphite, carbon aerogel, polyacrylonitrile (PAN), carbon nanofiber (CNF), activated carbon nanofiber (ACNF), vapor-grown carbon fiber (VGCF), and graphene.

Among them, an activated carbon having a specific surface area of 2000 to 3000 m²/g may be most preferably used.

The electrode active material, that is, activated carbon, which is used for the cathode and the anode, may be prepared by a vapor activation method, an alkali activation method, or the like. In the case where the electrode active material is prepared by the same preparation method, the particle size of the electrode active material used for the cathode and the anode may be controlled.

In addition, an electrolytic liquid, which includes, as an anion, at least one selected from the group consisting of Br⁻, BF₄⁻, and TFSI⁻, and, as a cation, at least one selected from the group consisting of 1,3-dialkylimidazolium, N-alkylpyridinium, tetra-alkylammonium, and tetra-alkylphosphonium, may be used for the electrochemical capacitor according to a first exemplary embodiment of the present invention.

In the case where an electrolytic liquid having the anion and the cation as above is used, they are easily adsorbed to and desorbed from a surface of the electrode active material, thereby realizing an increase in capacitance.

In addition, the electrochemical capacitor according to a second exemplary embodiment of the present invention is characterized in that electrode active materials being different from each other in view of a pore structure are used as materials for the cathode and the anode, respectively. Specifically, an electrode active material containing mesopores of 2 to 50 nm in a content of 60 to 80% is used for the cathode and an electrode active material containing micropores of 2 nm or less in a content of 60 to 80% is used for the anode.

The term used in the electrode active material of the present invention, ‘mesopore’ means that a pore within the electrode active material has a pore size of 2 to 50 nm.

Also, the term used in the electrode active material of the present invention, ‘micropore’ means that a pore within the electrode active material has a pore size of 2 nm or less.

For the cathode of the present invention, it is preferable to use an electrode active material where mesopores of 2 to 50 nm are developed, for example, they are included in a content of about 60 to 80%. In the case of the content of mesopores is within the above range, an anion of the electrolytic liquid, having a relatively large ion diameter, is preferable due to easy adsorption and desorption thereof.

According to an exemplary embodiment of the present invention, the electrode active material used for the cathode may be at least one carbon material selected from the group consisting of activated carbon, carbon nanotube (CNT), graphite, carbon aerogel, polyacrylonitrile (PAN), carbon nanofiber (CNF), activated carbon nanofiber (ACNF), vapor-grown carbon fiber (VGCF), and graphene.

According to one exemplary embodiment of the present invention, an activated carbon having a specific surface area of 1,500 to 2,000 m²/g may be preferably used for the electrode active material of the cathode.

Activated carbon, which is an electrode active material where mesopores are developed as above, may be preferably prepared by a vapor activation method.

In common, the activated carbon is subjected to heat treatment at a region of about 700 to 1500° C., followed by activation, and thus, surface porosity thereof is increased, resulting in an increased specific surface area.

When the vapor activation method is used to prepare activated carbon where mesopores are developed, the amount of functional groups, such as, a carboxyl group, a hydroxy group, and a carbonyl group, present on a surface of the activated carbon is minimized. The reason is that the possibility that a sub-reaction will occur is reduced as the amount of these functional groups becomes decreased. When the vapor activation method according to the present invention is used, the heat-treated activated carbon is preferably treated at a temperature of about 600 to 800° C. Activated carbon where mesopores of 2 to 50 nm are developed can be prepared by vapor activation at the above temperature.

A source of the activated carbon may be a non-graphitizable material, such as, a synthetic polymer, carbon black, glassy carbon, a palm tree timber, or the like, but is not particularly limited thereto.

Meanwhile, an electrode active material including micropores of 2 nm or less in a content of 60 to 80% may preferably be used for the anode of the present invention. In other words, it is preferable to use a material having a relatively larger micropore volume as compared with the electrode active material employed in the cathode. The micropores are contained in a content of 60 to 80% since the cation of the electrolytic liquid, having a relatively small ion diameter, is easily adsorbed and desorbed.

According to one exemplary embodiment of the present invention, the electrode active material used in the anode may be at least one carbon material selected from the group consisting of activated carbon, carbon nanotube (CNT), graphite, carbon aerogel, polyacrylonitrile (PAN), carbon nanofiber (CNF), activated carbon nanofiber (ACNF), vapor-grown carbon fiber (VGCF), and graphene.

According to one embodiment of the present invention, an activated carbon having a specific surface area of 2000 to 3,000 m²/g may be preferably used as the electrode active material of the anode.

The activated carbon, which is an electrode active material of the anode, may be preferably prepared by an alkali activation method. The alkali activation method may be prepared at a temperature of 600 to 1000° C. When the alkali activation method according to the present invention is used, the heat-treated activated carbon may be treated by using a strong alkali solution, such as, KOH or NaOH. Activated carbon where micropores of 2 nm or less are developed can be prepared by alkali activation at the above temperature.

According to one exemplary embodiment of the present invention, the cathode is preferably thin such that the cathode is formed more thinly than the anode by 5 to 40%. In other words, the cathode is formed more thinly than the anode within the above range, and thus, cell voltage can be increased due to a difference in resistance between the cathode and the anode.

The electrochemical capacitor according to the present invention has a structure where a cathode and an anode are insulated by a separator, which is impregnated with an electrolytic liquid. Here, the cathode is formed by coating a cathode active material slurry, which includes a cathode active material having mesopores of 2 to 50 nm, a conductive agent, a binder, and the like, on a cathode current collector. Also, the anode is formed by coating an anode active material slurry, which includes an anode active material having micropores of 2 nm or less, a conductive agent, a binder, and the like, on an anode current collector.

The electrolytic liquid according to the present invention may preferably include, as an anion, at least one selected from the group consisting of Br⁻, BF₄⁻, and TFSI⁻, and, as a cation, at least one selected from the group consisting of 1,3-dialkylimidazolium, N-alkylpyridinium, tetra-alkylammonium, and tetra-alkylphosphonium.

In the present invention, average particle sizes of cathode and anode active materials and pore sizes within the electrode active materials are controlled, so that counter ions within the electrolytic liquid are effectively adsorbed and desorbed when the electrodes are impregnated with the electrolytic liquid. Therefore, in the case where an electrolytic liquid having the anion and the cation as above is used, they are easily adsorbed to and desorbed from a surface of the electrode active material, thereby realizing an increase in capacitance.

In the electrochemical capacitor according to the present invention, a mixture of the electrode active material, the conductive agent, and the solvent may be molded in a sheet form by using the binder resin, or a molded sheet extruded by an extrusion method may be bonded to the current collector by using a conductive adhesive.

A material used in electrochemical capacitors or lithium ion batteries of the related art may be used for a cathode current collector. Examples of the material may be at least one selected from a group consisting of aluminum, stainless, titanium, tantalum, and niobium, and among them, aluminum is preferable.

Preferably, the cathode current collector may have a thickness of about 10 to 300 μm. An example of the current collector may include a metal foil, an etched metal foil, or those having holes penetrating through front and rear surfaces thereof, such as an expanded metal, a punching metal, a net, foam, or the like.

In addition, a material used in electrochemical capacitors or lithium ion batteries of the related art may be used for an anode current collector. Examples of the material may be stainless, copper, nickel, or an alloy thereof, and among them, copper is preferable. Preferably, the anode current collector may have a thickness of about 10 to 300 μm. An example of the current collector may include a metal foil, an etched metal foil, or those having holes penetrating through front and rear surfaces thereof, such as an expanded metal, a punching metal, a net, foam, or the like.

Examples of the conductive agent included in the cathode and anode active material slurry of the present invention may include a conductive powder, such as, Super-P, ketjen black, acetylene black, carbon black, graphite, or the like, but are not limited thereto. In other words, the examples of the conductive agent may include all kinds of conductive agents that can be used in general electrochemical capacitors.

Example of the binder resin may include at least one selected from fluorine-based resin such as polytetrafluoroethylene (PTFE), polyvinylidenefluoride (PVdF) and the like; thermoplastic resin such as polyimide, polyamideimide, polyethylene (PE), polypropylene (PP), and the like; cellulose-based resin such as carboxymethylcellulose (CMC) and the like; rubber-based resin such as styrene-butadiene rubber (SBR) and the like; and a mixture thereof, but are not limited thereto. Any binder resin that can be used in normal electrochemical capacitors may be used.

For the separator according to the present invention, any material that can be used in the used in electrochemical capacitors or lithium ion batteries of the related art may be used. A microporous film prepared from at least one polymer selected from the group consisting of polyethylene (PE), polypropylene (PP), polyvinylidene fluoride (PVDF), polyvinylidene chloride, polyacrylonitrile (PAN), polyacrylamide (PAAm), polytetrafluoroethylene (PTFE), poly-sulfone, polyethersulfone (PES), polycarbonate (PC), polyamide (PA), polyimide (PI), polyethylene oxide (PEO), polypropylene oxide (PPO), cellulose-based polymers, and polyacryl-based polymers may be used as the separator. In addition, a multilayer film in which the porous films are polymerized may be used, and among them, cellulose-based polymers may be preferably used.

The separator has a thickness of preferably 15 to 35 μm, but is not limited thereto.

As a case (exterior material) of the electrochemical capacitor of the present invention, a laminate film containing aluminum conventionally used in a secondary battery and an electrochemical capacitor may be used, but the case of the present invention is not particularly limited thereto.

Hereinafter, examples of the present invention will be described in detail. The following examples are only for illustrating the present invention, and the scope of the present invention should not be construed as being limited by these examples. In addition, specific compounds are used in the following examples, but it is obvious to those skilled in the art that equivalents thereof can exhibit the same or similar degrees of effects.

### Example 1

1) Manufacturing of Cathode

Palm tree charcoal as a source was subjected to heat treatment at 1000° C. The heat-treated material was treated with vapor activation at 650° C. for several hours, thereby obtaining activated carbon having a specific surface area of 1900 m²/g and an average particle size of 10 μm.

85 g of the prepared activated carbon, 18 g of Super-P as a conductive agent, and 3.5 g of CMC, 12.0 g of SBR, and 5.5 g of PTFE, as a binder, were mixed with 225 g of water, followed by stirring, thereby preparing a cathode active material slurry.

The cathode active material slurry was coated on a 20 μm-thick aluminum etching foil by using a comma coater, followed by temporary drying, and then cut into electrodes with a size of 50 mm×100 mm. The cathode had a cross-sectional thickness of 65 μm. The cathode was dried under the vacuum conditions at 120° C. for 48 hours, before cell assembling.

2) Manufacturing of Anode

Oil pitch coak as a source was subjected to heat treatment at 1200° C. The heat-treated material was treated with strong base activation at 800° C. for several hours, thereby obtaining activated carbon having a specific surface area of 2200 m²/g and an average particle size of 8 μm.

85 g of the prepared activated carbon, 18 g of Super-P as a conductive agent, and 3.5 g of CMC, 12.0 g of SBR, and 5.5 g of PTFE, as a binder, were mixed with 225 g of water, followed by stirring, thereby preparing an anode active material slurry.

The anode active material slurry was coated on a copper current collector by using a comma coater, followed by temporary drying, and then cut into electrodes with a size of 50 mm×100 mm. The anode had a cross-sectional thickness of 80 μm. The anode was dried under the vacuum conditions at 120° C. for 48 hours, before cell assembling.

3) Preparation of Electrolytic Liquid

An electrolytic liquid of acetonitrile solvent having tetra ethyl ammonium (TEA) as a cation and BF₄⁻ as an anion was prepared.

4) Assembling of Super Capacitor Electrical Storage Device Cell

A separator (TF4035 from NKK, cellulose-based separator) was inserted between the prepared electrodes (cathode and anode), followed by impregnation with the electrolytic liquid, and then the resulting structure was put and sealed in a laminate film case.

### Example 2

1) Manufacturing of Cathode

Palm tree charcoal as a source was subjected to heat treatment at 1000° C. The heat-treated material was treated with vapor activation at 650° C. for several hours, thereby obtaining activated carbon having a specific surface area of 1900 m²/g (where mesopores of 2 to 50 nm are included in a content of 60%).

85 g of the prepared activated carbon, 18 g of Super-P as a conductive agent, and 3.5 g of CMC, 12.0 g of SBR, and 5.5 g of PTFE, as a binder, were mixed with 225 g of water, followed by stirring, thereby preparing a cathode active material slurry.

The cathode active material slurry was coated on a 20 μm-thick aluminum etching foil by using a comma coater, followed by temporary drying, and then cut into electrodes with a size of 50 mm×100 mm. The cathode had a cross-sectional thickness of 80 μm. The cathode was dried under the vacuum conditions at 120° C. for 48 hours, before cell assembling.

2) Manufacturing of Anode

Oil pitch coak as a source was subjected to heat treatment at 1200° C. The heat-treated material was treated with strong base (KOH) activation at 800° C. for several hours, thereby obtaining activated carbon having a specific surface area of 2200 m²/g (where micropores of 2 nm or less are included in 70%).

85 g of the prepared activated carbon, 18 g of Super-P as a conductive agent, and 3.5 g of CMC, 12.0 g of SBR, and 5.5 g of PTFE, as a binder, were mixed with 225 g of water, followed by stirring, thereby preparing an anode active material slurry.

The anode active material slurry was coated on a copper current collector by using a comma coater, followed by temporary drying, and then cut into electrodes with a size of 50 mm×100 mm. The anode had a cross-sectional thickness of 80 μm. The cathode was dried under the vacuum conditions at 120° C. for 48 hours, before cell assembling.

3) Preparation of Electrolytic Liquid

An electrolytic liquid was prepared by using an acetonitrile solvent having tetra ethyl ammonium (TEA) as a cation and BF₄⁻ as an anion.

4) Assembling of Super Capacitor Electrical Storage Device Cell

A separator (TF4035 from NKK, cellulose-based separator) was inserted between the prepared electrodes (cathode and anode), followed by impregnation with the electrolytic liquid, and then the resulting structure was put and sealed in a laminate film case.

### Comparative Example 1

A cathode active material slurry and an anode active material slurry were prepared by the same procedure as Example 1 above, except that activated carbon subjected to alkali activation (a particle size of 10 μm and a specific surface area of 2200 m²/g) is used for a cathode active material and an anode active material, respectively.

The prepared cathode active material slurry and anode active material slurry were comma-coated on an aluminum current collector and a copper current collector, respectively, thereby manufacturing a cathode and an anode having a cathode cross-sectional thickness and an anode cross-sectional thickness each of 60 μm, respectively.

A separator (TF4035 from NKK, cellulose-based separator) was inserted between the manufactured electrodes (cathode and anode), followed by impregnation with the electrolytic liquid of acetonitrile solvent having tetra ethyl ammonium (TEA) as a cation and BF₄⁻ as an anion, and then the resulting structure was put and sealed in a laminate film case.

### Experimental Example

### Evaluation on Capacitance and Resistance of Super Capacitor Electrical Storage Device

Under the constant temperature conditions of 25° C., each of super capacitor electrical storage device cells manufactured according to Examples 1 to 2 and Comparative Example 1 was charged to 2.5V at a current density of 1 mA/cm² in a constant current-constant voltage mode, and then kept for 30 minutes. Then, the cell was discharged at a constant current of 1 mA/cm² three times. Then capacitance at the last cycle was measured. The results were tabulated in Table 1.

Resistance characteristic of each cell was measured by an ampere-ohm meter and an impedance spectroscopy, and the results were tabulated in Table 1.

TABLE 1

| | | Initial | | |
|---|---|---|---|---|
| | | capacitance | | After 10 |
| | | characteristic | | cycles of |
| | Initial | (F) @100 C | | 100 C rate |
| | capacitance | (capacitance | Resistance | charging |
| | characteristic | % against | Characteristic | and |
| | (F) @1 C | 1 C) | (AC ESR, mΩ) | discharging |
| Comparative | 22.1 | 20.5(93%) | 15.2 | 18.0(88%) |
| example 1 | | | | |
| Example 1 | 16.4 | 16.2(99%) | 10.4 | 15.7(97%) |
| Example 2 | 17.6 | 17.1(97%) | 13.1 | 16.0(94%) |

0.2 A Constant current condition 2.8~0 V discharging: about 1 C rate by C rate standards
20 A Constant current condition 2.8~0 V discharging: about 100 C rate by C rate standards

As shown in Table 1, it can be seen that Examples 1 and 2, in which a cell balance design concept is reflected realized low resistance and maintained a higher capacitance retention ratio even at the high C rate (high power) condition, as compared with the existing product (Comparative Example 1). It can be seen that Example 1 exhibited excellent capacitance retention ratio characteristics even at a cycle charging and discharging test by 100 C rate standards, due to this electrochemical behavior.

According to exemplary embodiments of the present invention, a large-capacitance electrochemical capacitor having excellent withstand voltage, energy density, input and output characteristics, and high-rate charging and discharging cycle reliability, by changing structures of electrodes and design of materials therefor such that the cathode and the anode include electrode active materials being different from each other in view of an average particle size, respectively, or electrode active materials being different from each other in view of a pore structure.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

What is claimed is:

1. An electrochemical capacitor, comprising:
a cathode using an electrode active material having an average particle size of 10 μm or larger; and
an anode using an electrode active material having an average particle size of below 10 μm.

2. The electrochemical capacitor according to claim 1, wherein the electrode active material of the anode and the electrode active material of the cathode are the same as or different from each other, and each thereof is at least one carbon material selected from the group consisting of activated carbon, carbon nanotube (CNT), graphite, carbon aerogel, polyacrylonitrile (PAN), carbon nanofiber (CNF), activated carbon nanofiber (ACNF), vapor-grown carbon fiber (VGCF), and graphene.

3. The electrochemical capacitor according to claim 1, wherein the electrode active material of the cathode is activated carbon having a specific surface area of 1,500 to 2,000 m²/g.

4. The electrochemical capacitor according to claim 1, wherein the electrode active material of the anode is activated carbon having a specific surface area of 2,000 to 3,000 m²/g.

5. An electrochemical capacitor comprising a cathode using an electrode active material including mesopores of 2 to 50 nm in a content of 60 to 80%; and an anode using an electrode active material including of micropores of below 2 nm in a content of 60 to 80%.

6. The electrochemical capacitor according to claim 5, wherein the electrode active material of the anode and the electrode active material of the cathode are the same as or different from each other, and each thereof is at least one carbon material selected from the group consisting of activated carbon, carbon nanotube (CNT), graphite, carbon aerogel, polyacrylonitrile (PAN), carbon nanofiber (CNF), activated carbon nanofiber (ACNF), vapor-grown carbon fiber (VGCF), and graphene.

7. The electrochemical capacitor according to claim 5, wherein the electrode active material of the cathode is activated carbon having a specific surface area of 1,500-2,000 m²/g.

8. The electrochemical capacitor according to claim 5, wherein the electrode active material of the anode is activated carbon having a specific surface area of 2,000 to 3,000 m²/g.

9. The electrochemical capacitor according to claim 7, wherein the activated carbon as the electrode active material of the cathode is prepared by a vapor activation method.

10. The electrochemical capacitor according to claim 9, wherein the vapor activation method is performed at a temperature of 600 to 800° C.

11. The electrochemical capacitor according to claim 8, wherein the activated carbon as the electrode active material of the anode is prepared by an alkali activation method.

12. The electrochemical capacitor according to claim 11, wherein the alkali activation method is performed at a temperature of 600 to 1000° C.

13. The electrochemical capacitor according to claim 1, wherein the cathode is formed more thinly than the anode by 5 to 40%.

14. The electrochemical capacitor according to claim 5, wherein the cathode is formed more thinly than the anode by 5 to 40%.

15. The electrochemical capacitor according to claim 5, further comprising an electrolytic liquid.

16. The electrochemical capacitor according to claim 15, wherein the electrolytic liquid includes Br⁻, BF₄⁻, and TFSI⁻ as an anion.

17. The electrochemical capacitor according to claim 15, wherein the electrolytic liquid includes at least one selected from the group consisting of 1,3-dialkylimidazolium, N-alkylpyridinium, tetra-alkylammonium, and tetra-alkylphosphonium, as a cation.
